(19) United States
(12) Patent Application Publication
(10) Pub. No.: US 2025/0215255 A1
(43) Pub. Date: Jul. 3, 2025

(54) COATING COMPOSITION, COATING FILM, LAMINATE, AND SLIDING MEMBER

(71) Applicant: DAIKIN INDUSTRIES, LTD., Osaka (JP)

(72) Inventors: Ryoko OGINO, Osaka (JP); Ozora SHIBATA, Osaka (JP); Yasukazu NAKATANI, Osaka (JP)

(73) Assignee: DAIKIN INDUSTRIES, LTD., Osaka (JP)

(21) Appl. No.: 19/086,368

(22) Filed: Mar. 21, 2025

Related U.S. Application Data
(63) Continuation of application No. PCT/JP2023/033343, filed on Sep. 13, 2023.

(30) Foreign Application Priority Data
Sep. 22, 2022 (JP) 2022-151884

(51) Int. Cl. C09D 133/24; B05D 5/08; C09D 5/02; C09D 7/20; C09D 7/40; C09D 7/65

(52) U.S. Cl. CPC C09D 133/24; B05D 5/083; C09D 5/028; C09D 7/20; C09D 7/65; C09D 7/68; C09D 7/69; B05D 2202/00; B05D 2505/50

(57) ABSTRACT

A coating composition that can form a coating film excellent in sliding properties and abrasion resistance. The coating composition includes a particle of tetrafluoroethylene/hexafluoropropylene copolymer, a binder resin and a liquid medium, where the above binder resin is at least one selected from the group consisting of a polyamide-imide resin, a polyetherimide resin, a polyimide resin, and a polyaryl ether ketone resin; and the above particle of the tetrafluoroethylene/hexafluoropropylene copolymer has a melt flow rate of 10 to 25 (g/10 min), a melting point of 270° C. or lower, and a median diameter (D50) of 0.1 to less than 10 μm, and a mass ratio of the above particle of the tetrafluoroethylene/hexafluoropropylene copolymer to the above binder resin is 55/45 to 94/6.

### CROSS REFERENCE TO RELATED APPLICATIONS

This application is a Rule 53 (b) Continuation of International Application No. PCT/JP2023/033343 filed Sep. 13, 2023, which claims priority from Japanese Patent Application No. 2022-151884 filed Sep. 22, 2022, the respective disclosures of all of the above are incorporated herein by reference in their entirety.

### TECHNICAL FIELD

The present disclosure relates to a coating composition, a coating film, a laminate, and a sliding member.

### BACKGROUND ART

Fluororesins have satisfactory sliding properties, heat resistance and the like, and are used for various applications such as sliding members and other industrial members, while being combined with binder resins such as polyamide-imide (PAI) and polyimide (PI).

Patent Literature 1 discloses a reed valve for an EGR device having a coating film composed of 65 to 75 parts by mass of a polyamide-imide resin, 10 to 20 parts by mass of a fluororesin powder, and 10 to 30 parts by mass of an inorganic powder.

Patent Literature 2 discloses a non-adhesive composition which includes a liquid medium, a fluoropolymer with a filler, and a polymer binder, wherein a ratio of the fluoropolymer with the filler to the binder is preferably from 15:85 to 30:70 by weight.

Patent Literature 3 discloses a composition that is used for a cooking utensil or a kitchen utensil, and includes a fluororesin, a heat-resistant resin, water, and a solvent having a boiling point of 235° C. or higher, wherein the fluororesin is a tetrafluoroethylene/hexafluoropropylene copolymer; the heat-resistant resin is at least one selected from the group consisting of polyarylene sulfide, polyether sulfone, polyamide-imide, polyimide, polyether imide, polyether ether ketone and aromatic polyester; and a mass ratio of the fluororesin to the heat-resistant resin is 1/99 to 30/70.

Patent Literature 4 discloses a coating composition that includes a fluororesin (A), a polyether ether ketone resin (B), and a binder resin (C) having an amide group and/or an imide group, wherein a mass ratio of the fluororesin (A) to the binder resin (C) holds (A)/(C)=70/30 to 5/95; and the polyether ether ketone resin (B) is 3 to 50 parts by mass per 100 parts by mass of the total of the fluororesin (A) and the binder resin (C).

Patent Literature 5 discloses a fluororesin film that includes particles of a tetrafluoroethylene-based polymer having a melting point of 200° C. or higher and a melt viscosity of 1×10¹⁰ Pa·s or lower at 380° C., and a cured product of a heat-curable polymer which does not contain a fluorine atom, wherein when A represents an amount of fluorine atoms present on one surface of the fluororesin film, which is quantified by an energy dispersive type X-ray analysis, and B is an amount of fluorine atoms present on the other surface of the fluororesin film, a ratio B/A is 0.6 to 1.7.

Patent Literature 6 discloses a fluororesin film that includes a tetrafluoroethylene-based polymer having a melting point of 200° C. or higher and a melt viscosity of 1×10¹⁰ Pa·s or lower at 380° C.; and particles of a functional compound that contains at least one specific atom selected from the group consisting of titanium, silicon, magnesium, aluminum, cerium and nitrogen, and adjusts characteristics based on the tetrafluoroethylene-based polymer, wherein when A represents an amount of the specific atoms present on one surface of the fluororesin film, which is quantified by an energy dispersive X-ray analysis, and B is an amount of the specific atoms present on the other surface of the fluororesin film, a ratio B/A is 0.6 to 1.7.

Patent Literature 7 discloses a coating composition that includes a heat-resistant binder resin, a heat-meltable fluororesin and an organic solvent, wherein the heat-meltable fluororesin is a powder having an average particle size of 1.0 μm or smaller; a melting point is 270° C. or higher; a melt flow rate is 15 to 45 g/10 minutes; and the heat-meltable fluororesin is 10 to 200 parts by mass with respect to 100 parts by mass of the heat-resistant binder resin.

### CITATION LIST

### Patent Literature

Patent Literature 1: Japanese Patent Application Laid-Open No. 2012-149610
Patent Literature 2: National Publication of International Patent Application No. 2002-516618
Patent Literature 3: Japanese Patent Application Laid-Open No. 2020-50878
Patent Literature 4: Japanese Patent Application Laid-Open No. 2007-238686
Patent Literature 5: Japanese Patent Application Laid-Open No. 2020-37661
Patent Literature 6: Japanese Patent Application Laid-Open No. 2020-37662
Patent Literature 7: WO 2022-054916

### SUMMARY

The present disclosure relates to a coating composition that includes a particle of a tetrafluoroethylene/hexafluoropropylene copolymer, a binder resin, and a liquid medium, wherein the above binder resin is at least one selected from the group consisting of a polyamide-imide resin, a polyetherimide resin, a polyimide resin, and a polyaryl ether ketone resin; the above particles of the tetrafluoroethylene/hexafluoropropylene copolymer have a melt flow rate of 10 to 25 (g/10 min), a melting point of 270° C. or lower, and a median diameter (D50) of 0.1 to 50 μm, and a mass ratio of the above particles of the tetrafluoroethylene/hexafluoropropylene copolymer to the binder resin is 55/45 to 94/6.

### Advantageous Effects

The coating composition of the present disclosure can provide a coating film excellent in sliding properties, and accordingly is suitably applied to a sliding member or the like.

### DESCRIPTION OF EMBODIMENTS

The present disclosure will be described below. Conventionally, a coating composition which uses a combination of a fluororesin and a binder resin has been used in a wide range of applications. On the other hand, it is difficult to uniformly mix the fluororesin in a liquid medium, and the problem has been that the fluororesin causes aggregation or segregation in the resulting coating film, in some cases. Because of this, it is difficult to incorporate a high amount of fluororesin in a coating composition, and a coating composition containing a large amount of binder resin has been commonly used (for example, the fluorine-containing coating compositions in Patent Literatures 1 to 3).

In such a conventional fluorine-containing coating composition, it has often been the case that when a coating film is formed, only the binder resin is melted and fluidized, and fluororesin particles are maintained in a state of being dispersed in the binder resin.

In particular, when the fluororesin is PTFE, it is difficult to melt and flow the fluororesin because of showing high viscosity at the time of melting, and the fluororesin is in a state of being dispersed in a matrix resin in a state of particles. In such a state, it is difficult to form a satisfactory coating film from the coating composition containing a large amount of the fluororesin.

On the other hand, in order to obtain an effect of the sliding property, the fluororesin results in being mainly responsible for its performance. The sliding properties are physical properties of the coating film surface, and accordingly, when the fluororesin is unevenly distributed on a coating film surface side, these performances can be more enhanced. However, in order to make the fluororesin unevenly distributed on the coating film surface side, it becomes necessary to use a fluororesin which is easily unevenly distributed.

In the present disclosure, a fluororesin is used which has a relatively low melting point and high flowability, and is thereby enabled to be blended in a high proportion in the coating composition. Furthermore, the fluororesin is used which is easily flowable when having been melted, thereby becomes easy to be unevenly distributed on the coating film surface side when the coating film is formed, and can provide high sliding properties which have not been obtained in a conventional fluorine-containing coating composition.

The coating composition of the present disclosure is a coating composition that includes a particle of a tetrafluoroethylene (TFE)/hexafluoropropylene (HFP) copolymer (FEP), a binder resin, and a liquid medium, wherein the above binder resin is at least one selected from the group consisting of a polyamide-imide resin, a polyetherimide resin, a polyimide resin, and a polyaryl ether ketone resin; the above FEP particles have a melt flow rate of 10 to 25 (g/10 min), a melting point of 270° C. or lower, and a median diameter (D50) of 0.1 to 50 μm; and a mass ratio of the above FEP particles to the binder resins is 55/45 to 94/6.

In such a coating composition, the FEP resin particles are not dissolved in a solvent in the state of a coating, and the binder resin is dissolved in the solvent to contribute to the formation of the coating film at the time of coating. When the coating composition is melted by heat, both the binder resin and the FEP resin are melted to form a coating film. At this time, the binder resin and the FEP resin are incompatible even when having been melted, and the FEP resin having a lower surface free energy tends to be easily unevenly distributed on the surface side of the coating film. Thereby, the high sliding properties can be obtained.

### (FEP Particle)

The above FEP is not limited, and is preferably a copolymer having a molar ratio of THE unit to HFP unit (TFE unit/HFP unit) of 70/30 or larger and smaller than 99/1. The molar ratio is more preferably 70/30 or larger and 98.9/1.1 or smaller, and is further preferably 80/20 or larger and 98.9/1.1 or smaller. When the TFE unit is too few, the mechanical properties tend to be lowered, and when the TFE unit is too many, the melting point becomes too high and the moldability tends to be lowered. It is also preferable that the above FEP is a copolymer in which a monomer unit originating in a monomer which can be copolymerized with TFE and HFP is 0.1 to 10 mol %, and a total of the TFE unit and the HFP unit is 90 to 99.9 mol %. Examples of the monomer copolymerizable with TFE and HFP include perfluoro (alkyl vinyl ether) (PAVE), and an alkyl perfluorovinyl ether derivative represented by CF₂═CF—OCH₂—Rf² (wherein Rf² represents a perfluoroalkyl group having 1 to 5 carbon atoms).

Examples of the above PAVE include perfluoro(methyl vinyl ether) (PMVE), perfluoro (ethyl vinyl ether) (PEVE), and perfluoro (propyl vinyl ether) (PPVE).

A content of each monomer unit of the above FEP particle can be calculated by appropriately combining NMR, FT-IR, elemental analysis and X-ray fluorescence analysis, according to the type of the monomer.

Furthermore, the FEP particle to be used in the present disclosure satisfies the following physical properties. When the melt flow rate, melting point and median diameter of the above FEP particles are controlled within desired ranges shown below, the FEP particles can be stably incorporated in a high proportion in the coating composition. Furthermore, the above FEP particles maintain satisfactory dispersibility and flowability even when the coating film formed from the coating composition is fired, accordingly, the FEP particles resists causing aggregation and tend to be unevenly distributed on the coating film surface side after having been fired; and thereby, a coating film excellent in sliding properties can be obtained.

The above FEP particles have a melt flow rate (MFR) of 10 to 25 (g/10 min), preferably 13 to 23 (g/10 min), and more preferably 15 to 20 (g/10 min). When the above MFR is 10 or smaller, processability is reduced, and the fluororesin resists being unevenly distributed on the coating film surface side, which may reduce lubricity. When the MFR exceeds 25, the flowability is high and may cause interlayer peeling.

In the present specification, the above MFR is a value that is obtained as a mass of a polymer (g/10 min) which flows out per 10 minutes from a nozzle having an inside diameter of 2 mm and a height of 8 mm at a measurement temperature (for example, 372° C. in the case of FEP) and a load (for example, 5 kg in the case of FEP) which are determined according to the type of the fluoropolymer, with the use of a Melt Indexer (manufactured by Yasuda Seiki Seisakusho, Ltd.) according to ASTM D1238.

The above FEP particles have a melting point of lower than 270° C., is preferably of lower than 265° C., and is more preferably of lower than 260° C. It is preferable that the lower limit of the above melting point is 220° C. When the above melting point exceeds 270° C., a processing temperature needs to be increased, and in this case, curing of the binder resin tends to easily proceed, which may hinder uneven distribution of the fluororesin onto the coating film surface.

In the present specification, the above melting point is a temperature corresponding to the maximum value in a heat-of-fusion curve which is obtained at the time when the FEP particles are heated at a rate of 10° C./min with the use of a differential scanning calorimeter (DSC).

As an index of uneven distribution of the fluororesin on the coating film surface side, the surface segregation rate of fluorine atoms on the coating film surface can be evaluated by EDX (energy dispersive X-ray analysis). It is preferable for the surface segregation rate of fluorine atoms to be 50% by mass or larger, is more preferable to be 60% by mass or larger, and is further preferable to be 70% by mass or larger.

Friction coefficient of the coating film surface can be evaluated by Tribo Gear (manufactured by Shinto Scientific Co., Ltd.). It is preferable for the friction coefficient of the coating film to be 0.09 or smaller, is more preferable to be 0.08 or smaller, and is further preferable to be 0.07 or smaller. In addition, an abrasion resistance can be evaluated by a reciprocating abrasion test which uses Friction Player (manufactured by Rhesca Co., Ltd.). In conjunction with a preferable range of the above friction coefficient, it is preferable for the abrasion resistance at 25° C. to be 1300 seconds or larger, is more preferable to be 1400 seconds or larger, and is further preferable to be 1500 seconds or larger. Furthermore, it is preferable for the abrasion resistance at 150° C. to be 600 seconds or larger, is more preferable to be 700 seconds or larger, and is further preferable to be 800 seconds or larger.

By having such a friction coefficient and abrasion resistance, the coating film is enabled to be excellent in the lubricity and in durability, and the coating film is enabled to be applicable to applications requiring the sliding property.

The above FEP particles have a median diameter (D50) of 0.1 to 50 μm, preferably of 0.1 to 5 μm, and more preferably of 0.1 to 1 μm.

When the above median diameter is within the above range, the FEP particles exhibit satisfactory dispersibility in the resulting coating film, and can make a coating film excellent in heat resistance and non-stickiness formed on the surface.

For information, in the present specification, the above median diameter means a particle size (so-called 50% particle size) of a particle at the time when the cumulative amount of solid particles from the smallest particle with respect to the total amount of solid particles is 50%, in the case where a particle size distribution curve of the particle size and the amount of solid particles has been determined. The above median diameter can be measured directly on the coating composition of the present disclosure.

It is preferable that the above FEP particles have an initial pyrolysis temperature of 360° C. or higher. It is preferable for the above initial pyrolysis temperature to be 380° C. or higher, and is further preferable to be 390° C. or higher.

In the coating composition of the present disclosure, a mass ratio of the above FEP particles to the above binder resin is 55/45 to 94/6. In other words, the coating composition of the present disclosure is a coating composition in which FEP particles are blended with a binder resin in a higher proportion than in a known fluorine-containing resin coating composition. When the above mass ratio is smaller than the lower limit, excellent sliding properties may not be obtained. When the above mass ratio exceeds the upper limit, the adhesion between the resulting coating composition and the substrate may become insufficient.

The above mass ratio of the FEP particles to the binder resin is preferably 55/45 to 80/20, and is more preferably 60/40 to 70/30.

The coating composition of the present disclosure further contains a binder resin.

It is preferable that the above binder resin is a resin that is excellent in adhesion to the substrate and is also excellent in heat resistance. Specifically, the resin is at least one selected from the group consisting of a polyamide-imide resin, a polyetherimide resin, a polyimide resin, and a polyaryl ether ketone resin; and two or more types thereof may be used in combination.

The above polyamide-imide resin (PAI) is a resin formed of a polymer having an amide bond and an imide bond in the molecular structure. The above PAI is not limited, and examples thereof include resins formed of high-molecular-weight polymers which are obtained by each reaction of: a reaction between an aromatic diamine having an amide bond in the molecule and an aromatic tetravalent carboxylic acid such as pyromellitic acid; a reaction between an aromatic trivalent carboxylic acid such as trimellitic anhydride and a diamine such as 4,4-diaminophenyl ether, or a diisocyanate such as diphenylmethane diisocyanate; and a reaction between a dibasic acid having an aromatic imide ring in the molecule and a diamine. The above PAI is preferably formed of a polymer having an aromatic ring in the main chain, because of being excellent in the heat resistance.

The above polyetherimide resin (PEI) is a resin formed of a polymer having an ether bond and an imide bond in the molecular structure. The above PEI is not limited, and examples thereof include resins formed of a high-molecular-weight polymer obtained by a reaction between 2,2-bis [4-(3,4-dicarboxyphenoxy)phenyl] propane and m-phenylenediamine in an organic solvent. The above PEI is preferably formed of a polymer having an aromatic ring in the main chain, because of being excellent in the heat resistance.

The above polyimide resin (PI) is a resin formed of a polymer having an imide bond in the molecular structure. The above PI is not limited, and examples thereof include resins formed of a high-molecular-weight polymer obtained by a reaction of an aromatic tetracarboxylic acid anhydride such as pyromellitic anhydride, or the like. The above PI is preferably formed of a polymer having an aromatic ring in the main chain, because of being excellent in the heat resistance.

Specific examples of the above aromatic polyether ketone resin referred to as a polyaryl ether ketone resin (PAEK) include polyether ether ketone (PEEK), polyether ketone ketone (PEKK), polyether ketone (PEK), and polyether ether ketone ketone (PEEKK).

The above aromatic polyether ketone resins are not limited as long as the resins contain a repeating unit which is formed of an arylene group, an ether group [—O—], and a carbonyl group [—C(═O)—], and contain, for example, a repeating unit represented by any of the following formulae (a1) to (a5).

[—Ar—O—Ar—C(═O)—] (a1),

[—Ar—O—Ar—C(═O)—Ar—C(═O)—] (a2),

[—Ar—O—Ar—O—Ar—C(═O)—] (a3),

[—Ar—O—Ar—C(═O)—Ar—O—Ar—C(═O)—Ar—C(═O)—] (a4), and

[—Ar—O—Ar—O—Ar—C(═O)—Ar—C(═O)—] (a5),
wherein Ar represents a divalent aromatic hydrocarbon ring group optionally having a substituent.

Examples of the divalent aromatic hydrocarbon ring group represented by Ar include: arylene groups having 6 to 10 carbon atoms such as phenylene groups (o-, m- or p-phenylene group, or the like) and naphthylene groups; biarylene groups (where the number of carbon atoms of each arylene group is 6 to 10) such as biphenylene groups (2,2′-biphenylene group, 3,3′-biphenylene group, 4,4′-biphenylene group, and the like); and tetrarylene groups (where the number of carbon atoms of each arylene group is 6 to 10) such as o-, m- or p-terphenylene group. These aromatic hydrocarbon ring groups optionally have a substituent, for example, a halogen atom, an alkyl group (a straight chain or branched chain alkyl group having 1 to 4 carbon atoms, such as a methyl group, or the like), a haloalkyl group, a hydroxyl group, an alkoxy group (a straight chain or branched chain alkoxy group having 1 to 4 carbon atoms, such as a methoxy group, or the like), a mercapto group, an alkylthio group, a carboxyl group, a sulfo group, an amino group, an N-substituted amino group, a cyano group, or the like. For information, in the repeating units (a1) to (a5), the types of Ar may be the same as or different from each other. Preferable examples of Ar include a phenylene group (for example, a p-phenylene group) and a biphenylene group (for example, a 4,4′-biphenylene group).

Examples of resins having the repeating unit (a1) include polyether ketone (for example, “PEEK-HT” produced by Victrex plc. Com.). Examples of resins having the repeating unit (a2) include polyether ketone ketone (for example, “PEKK” produced by Arkema+Oxford Performance Material Inc.). Examples of the resins having the repeating unit (a3) include: polyether ether ketone (for example, “VICTREX PEEK” produced by Victrex plc. Com., “Vestakeep (registered trade name)” produced by Evonik, “Vestakeep-J” produced by Daicel-Evonik Corporation, and “KetaSpire (registered trade name)” produced by Solvay Speciality Polymers Corporation); and polyether-diphenyl-ether-phenyl-ketone-phenyl (for example, “Kadel (registered trade name)” produced by Solvay Speciality Polymers corporation). Examples of resins having the repeating unit (a4) include polyether ketone ether ketone ketone (for example, “VICTREX ST” produced by Victrex plc. Com.). Examples of the resins having the repeating unit (a5) include polyether ether ketone ketone. In the repeating unit including an arylene group, an ether group and a carbonyl group, a proportion E/K of an ether segment (E) to a ketone segment (K) is, for example, 0.5 to 3, and is preferably about 0.5 to 2.0. The ether segment imparts flexibility to the molecular chain and the ketone segment imparts rigidity to the molecular chain; and accordingly, the more the ether segment is, the higher the crystallization rate is and the higher the finally attainable degree of crystallinity is; and the more the ketone segment is, the higher the glass transition temperature and the melting point tend to be. These aromatic polyether ketone resins can be used alone or in combination of two or more types.

Among these aromatic polyether ketone resins, an aromatic polyether ketone resin having any of the repeating units (a1) to (a4) is preferable. For example, the above aromatic polyether ketone resin is preferably at least one resin selected from the group consisting of polyether ketone, polyether ether ketone, polyether ketone ketone, and polyether ketone ether ketone ketone. Furthermore, the resin is more preferably at least one resin selected from the group consisting of polyether ketone, polyether ether ketone, and polyether ketone ketone. In particular, polyether ketone ketone is preferable because electric wire processability is enhanced and a dielectric constant is low.

It is preferable that the above aromatic polyether ketone resin has a melting point of 300° C. or higher. The melting point is more preferably 320° C. or higher. When the melting point is in the above range, the heat resistance of the obtained formed article can be enhanced.

It is preferable that the above aromatic polyether ketone resin has a glass transition temperature (Tg) of 130° C. or higher. The temperature is more preferably 135° C. or higher, and is further preferably 140° C. or higher. When the glass transition temperature is in the above range, an insulated electric wire can be obtained which is excellent in the heat resistance. The upper limit of the glass transition temperature is not limited, and is preferable to be 220° C. or lower, and is more preferable to be 180° C. or lower, from the viewpoint of moldability.

The above glass transition temperature is measured under measurement conditions including a temperature-increasing rate of 20° C./min with the use of a differential scanning calorimeter (DSC), in accordance with JIS K7121.

In the above coating composition, it is preferable for the total amount of the above FEP particles and the above binder resin to be 15 to 35% by mass with respect to the total amount of the fluororesin, the binder resin and the liquid medium which constitute the above coating composition, is more preferable to be 18% by mass or more, and is more preferable to be 30% by mass or less. When the total amount of the above FEP particles and the above binder resin is within the above range, the coating film can be formed which is more excellent in the adhesion to the substrate.

The coating composition of the present disclosure includes a liquid medium that dissolves the above binder resin and serves as a dispersion medium for the above FEP particles. Such a liquid medium is not limited, and for example, at least one can be used which is selected from the group consisting of N-methyl-2-pyrrolidone, N-ethyl-2-pyrrolidone, N-butyl-2-pyrrolidone, 3-methoxy-N,N-dimethylpropanamide, and N, N-dimethylacetamide.

The amount of the above liquid medium to be blended can be selected within a range that gives a coating film-forming property to the resulting coating composition and also gives a coating viscosity suitable for a coating method.

The coating composition of the present disclosure can further include, for example, conventionally used additives such as pigments, luster agents, antibacterial agents and fillers, as other components, within such a range as not to impair the effects of the coating composition of the present disclosure.

The above total amount of the other components to be blended may be in a range of up to 50% by mass of the total amount of the above FEP particles and the above binder resin, from such a viewpoint as not to reduce non-stickiness of the coating film formed of the obtained coating composition.

In addition, the coating composition of the present disclosure may contain a coloring pigment. Examples of the coloring pigment include titanium oxide, cobalt oxide, carbon and chromium oxide.

It is preferable for a content of the above coloring pigment to be 0.01% by mass or more, with respect to the total mass of the FEP resin and the binder resin, and is more preferable to be 0.03% by mass or more. When the amount of the coloring pigment is less than 0.01% by mass, there is a case where the intended coloring is not obtained. In addition, it is preferable for the content of the above coloring pigment to be 5% by mass or less, with respect to the total mass of the FEP resin and the binder resin, and is more preferable to be 38 by mass or less. When the amount of the coloring pigment is more than 5% by mass, brittleness of the obtained coating film becomes remarkable, which may lead to a decrease in abrasion resistance.

In addition, the coating composition of the present disclosure may also contain a filler. The inclusion of the filler generally enhances the hardness of the coating film. In this case, the abrasion of the coating film itself tends to be easily suppressed during sliding, but on the other hand, there is a case where the abrasion of the counterpart member is promoted during sliding. Because of this, it is preferable to appropriately select the necessity of containing the filler and the amount of the filler to be blended, according to the use environment of the sliding portion.

When the filler is selected, the new Mohs hardness can be used as an index. The new Mohs hardness is a relative hardness of a substance, which is evaluated in a range of 1 to 15.

When it is required to suppress abrasion of the counterpart member, it is preferable to use a filler having a new Mohs hardness of less than 7. Such a filler is not limited, and examples thereof include talc (new Mohs hardness 1), graphite (new Mohs hardness 2), boron nitride (new Mohs hardness 2), mica (new Mohs hardness 3), aluminum hydroxide (new Mohs hardness 3), calcium carbonate (new Mohs hardness 3), calcium fluoride (new Mohs hardness 4), zinc oxide (new Mohs hardness 4 to 5), tricalcium phosphate (new Mohs hardness 5), and iron oxide (new Mohs hardness 6). Among these chemical compounds, it is preferable for the filler to be at least one selected from the group consisting of graphite and iron oxide, from the viewpoint of suppressing both of abrasion of the coating film itself and abrasion of the counterpart member, at the time of sliding. Alternatively, two or more of these chemical compounds may be used in combination.

On the other hand, when it is particularly required to suppress the abrasion of the coating film itself, it is preferable to use a filler having a new Mohs hardness of 7 or higher. Such a filler is not limited, and examples thereof include silica (new Mohs hardness 7), glass flakes (new Mohs hardness 7), silicon dioxide (new Mohs hardness 7), quartz (new Mohs hardness 8), topaz (new Mohs hardness 9), garnet (new Mohs hardness 10), zirconia (new Mohs hardness 11), tantalum carbide (new Mohs hardness 11), alumina (new Mohs hardness 12), tungsten carbide (new Mohs hardness 12), silicon carbide (new Mohs hardness 13), boron carbide (new Mohs hardness 14), diamond (new Mohs hardness 15), fluorinated diamond (new Mohs hardness 15), and cubic boron nitride (new Mohs hardness 15). Among these chemical compounds, it is preferable for the filler to be at least one selected from the group consisting of silicon dioxide, quartz, and alumina, from the viewpoint of reducing abrasion of the counterpart member. Alternatively, two or more of these chemical compounds may be used in combination.

The coating composition of the present disclosure has excellent abrasion resistance, and can be used as a coating material for a sliding material that can be used in a high-temperature and high-heat generation environment. Specific examples of the product include members for a compressor piston of an air conditioner, a swash plate, and a scroll compressor. In particular, it is preferable for the coating composition to be used for the compressor piston of a car air conditioner. In a severer situation, it is preferable to use a filler having a new Mohs hardness of 7 or higher. Whether a filler having a low hardness or a filler having a high hardness is used depends on a customer's request, and a wide range of fillers can be selected. The substrate, the coating method and the like in such applications can be selected based on known methods.

It is preferable for an average particle size of the primary particles of the filler to be 0.1 μm or larger, is more preferable to be 0.3 μm or larger, and is further preferable to be 0.5 μm or larger. In addition, it is preferable for an average particle size of the primary particles of the filler to be 30 μm or smaller, is more preferable to be 25 μm or smaller, and is further preferable to be 20 μm or smaller.

The average particle size of the primary particles of the filler can be measured in the following way. Firstly, particles in a visual field are photographed by a transmission electron microscope or a scanning electron microscope. Then, the longest length (maximum length) of the inner diameter of each particle is determined for 300 primary particles constituting the aggregate on a two-dimensional image. An average value of the maximum lengths of the individual particles is defined as the average particle size of the primary particles.

It is preferable for a content of the filler to be 20% by mass or less with respect to the total mass of the FEP resin and the binder resin, is more preferable to be 15% by mass or less, and is further preferable to be 12% by mass or less. When the amount of the filler exceeds 20% by mass, brittleness of the obtained coating film becomes remarkable, which may lead to a decrease in the abrasion resistance.

The coating composition of the present disclosure can be produced according to a usual method. For example, the coating composition can be produced by stirring and mixing each component with the use of a stirring and mixing apparatus such as a ball mill, a three-roll mill and a disper.

It is preferable for a solid content concentration of the coating composition of the present disclosure to be 10 to 50% by mass, is more preferable to be 15% by mass or higher, and is more preferable to be 35% by mass or lower, from the viewpoint of coatability.

The present disclosure also provides a coating film formed from the above coating composition. The coating film obtained from the above coating composition is excellent in coating film strength and is further excellent also in the sliding property. The above coating film has a thickness of generally 5 to 100 μm and preferably 10 to 50 μm.

The above thickness can be measured with the use of an eddy current film thickness measuring device (manufactured by Kett Electric Laboratory Co. Ltd.).

Furthermore, the present disclosure also provides a laminate that features having a coating film formed from the above coating composition on a substrate.

The above substrate is not limited, because the coating composition of the present disclosure can be applied to a wide variety of objects to be coated. Examples thereof include substrates formed from metals such as aluminum, stainless steel [SUS], and iron; heat-resistant resins; ceramics; and the like; and it is preferable that the substrates are formed from metals. The metal may be a simple metal or an alloy.

It is preferable that the above substrate has been subjected to surface roughening treatment such as blasting treatment, and/or chemical conversion treatment with the use of a phosphate or the like, before being coated with the coating, from the viewpoint of enhancing the adhesion to the coating film.

It is preferable that an average surface roughness [Ra] of the above substrate is 2 to 10 μm. The above average surface roughness is a value measured in accordance with JIS D0601.

The above coating film can be formed by application of the above coating composition onto the substrate. The above coating composition may be applied by any conventionally known method, and examples of the method include spray coating and roller coating. The coating film may be fired after the coating composition has been applied as in the above, and then dried at 80 to 150° C. as desired. A temperature of the above firing is preferably 200 to 300° C., and is more preferably 230 to 280° C.

The above firing can be performed generally for 15 to 120 minutes, and preferably for 30 to 60 minutes.

After the above firing, the laminate may be further subjected to other steps such as surface treatment of the obtained coating film and processing into a desired shape according to various applications.

The laminate in the present invention is excellent in the sliding properties; accordingly, can be used, for example, as an industrial component such as a sliding member, a papermaking roll, a calender roll, a mold release part, a casing, a valve, a packing, a coil bobbin, an oil seal, a joint, an antenna cap, a connector, a gasket, a valve seal, a buried bolt, a buried nut, and the like; and among the industrial components, can be suitably used as the sliding member.

Examples of the above sliding member include precision mechanism sliding members including compressors of car air conditioners and swash plates to be used therein, bearing materials, bearing plates, and various gears.

### EXAMPLES

The present disclosure will be described below with reference to Examples. In Examples, % and parts in the blending proportion mean by mass and parts by mass, unless otherwise specified. The present disclosure is not limited to the Examples described below.

The fluororesin particle, the binder resin, the coloring pigment and the filler which have been used are shown below.

Fluororesin (FEP) particle A: 15.7% by mass of HFP, melt flow rate of 15 g/10 min, melting point of 267° C., and median diameter of 0.15 μm.

Fluororesin (FEP) particle B: 16.0% by mass of HFP, 2.6% by mass of PPVE, melt flow rate of 20 g/10 min, melting point of 259° C., and median diameter of 0.14 μm.

Fluororesin (FEP) particle C: (dispersed in methyl isobutyl ketone) 21.8% by mass of HFP, melt flow rate of 17 g/10 min, melting point of 227° C., and median diameter of 0.11 μm.

Fluororesin (FEP) particle D: 16.0% by mass of HFP, 2.6% by mass of PPVE, melt flow rate of 2 g/10 min, melting point of 259° C., and median diameter of 0.14 μm.

Fluororesin (FEP) particle E: 16.0% by mass of HFP, 2.6% by mass of PPVE, melt flow rate of 29 g/10 min, melting point of 258° C., and median diameter of 0.14 μm.

Fluororesin (FEP) particle F: 16.0% by mass of HFP, 2.6% by mass of PPVE, melt flow rate of 20 g/10 min, melting point of 259° C., and median diameter of 0.05 μm.

Fluororesin (FEP) particle G: 16.0% by mass of HFP, 2.6% by mass of PPVE, melt flow rate of 20 g/10 min, melting point of 259° C., and median diameter of 45 μm.

Fluororesin (FEP) particle H: 16.0% by mass of HFP, 2.6% by mass of PPVE, melt flow rate of 20 g/10 min, melting point of 259° C., and median diameter of 60 μm.

Fluororesin (PFA) particle I: 4.18 by mass of PPVE, melt flow rate of 29 g/10 min, melting point of 315° C., and median diameter of 0.30 μm.

Fluororesin (PTFE) particle J: (dispersed in methyl isobutyl ketone), melting point of 329° C., and median diameter of 0.25 μm.

Fluororesin (PTFE) particle K: melting point of 329° C., and median diameter of 4.1 μm.

Binder resin L: polyamide-imide vanish HPC-5000, produced by Showa Electric Materials, Co. Ltd., 30% by mass of solid content, and main solvent of N-methyl-2-pyrrolidone.

Binder resin M: polyamide-imide varnish Elan-tech 603G produced by Elantas Com., 35% by mass of solid content, and main solvent of 3-methoxy-N,N-dimethylpropanamide.

Binder resin N: polyetherimide varnish obtained by dissolving ULTEM 1000F3SP produced by SABIC in N-methyl-2-pyrrolidone, and 25% by mass of solid content.

Binder resin 0: polyimide varnish obtained by dissolving AURUM PD450 produced by Mitsui Chemicals, Inc. in N-methyl-2-pyrrolidone, and 25% by mass of solid content.

Binder resin P: polyether ether ketone dispersion obtained by dissolving KT-820 produced by Solvay Specialty Polymers Japan K.K., in N-methyl-2-pyrrolidone, and 25% by mass of solid content.

Coloring pigment Q: titanium oxide (FR-22, average particle size of 0.6 μm) produced by Furukawa Chemicals Co., Ltd.

Coloring pigment R: carbon black (MA-100, average particle size of 0.02 μm) produced by Mitsubishi Chemical Group Corporation.

Filler S: talc (Wako first grade, average particle size of 8 μm) produced by Fujifilm Wako Pure Chemical Corporation, and new Mohs hardness 1.

Filler T: Graphite (J-CPB, average particle size of 5 μm) produced by Nippon Graphite Industries, Co., Ltd., and new Mohs hardness 2.

Filler U: quartz (fused silica FB-5D, average particle size of 4.7 μm) produced by Denka Company Limited, and new Mohs hardness 8.

Filler V: zirconia (DK-3CH, average particle size of 14 μm) produced by Daiichi Kigenso Kagaku Kogyo Co., Ltd., and new Mohs hardness 11.

Filler W: silicon carbide (GC2500, average particle size of 5.5 μm) produced by Shinano Electric Refining Co., Ltd., and new Mohs hardness 13.

### Examples 1 to 20, and Comparative Examples 1 to 9

A fluororesin dispersion composition was obtained by mixing one or more of fluororesin particles A to K as a fluororesin, any of binder resins L to P as a binder resin, and N-methyl-2-pyrrolidone, 3-methoxy-N,N-dimethylpropanamide, and methyl isobutyl ketone, at a predetermined mass ratio.

In addition, in some of Examples and Comparative Examples, the fluororesin dispersion composition was obtained by simultaneously mixing Q and R as coloring pigments, and any of S to W as fillers at the time of preparation of the above composition.

A coating film having a total film thickness of 15 μm was obtained by applying the above fluororesin dispersion composition onto a degreased aluminum plate by spray coating, drying the resulting film at 100° C. for 30 minutes, and then firing the dried film at 280° C. for 30 minutes.

The stability of the compositions obtained in the above Examples and Comparative Examples, and the factors of the sliding properties of the coating films obtained from these compositions were evaluated in the following way, where the factors were the time until the coating film was abraded away, the amount of abrasion of the counterpart material, and a friction coefficient of the coating film.

### (Stability of Composition)

The stability (presence or absence of agglomerates, and the like) after the preparation of the composition was visually evaluated.
Good: agglomerates do not remain at the time of filtration.
Poor: agglomerates or gel-like substances are observed at the time of filtration.

### (Time Until Coating Film is Abraded Away)

The time (sec) until the coating film was peeled off and the aluminum plate was exposed at 25° C. and 150° C. was measured by a reciprocating abrasion test with the use of Friction Player (manufactured by Rhesca Co., Ltd.). A ball-shaped silicon dioxide (new Mohs hardness 7) was used as a measuring probe.

### (Amount of Abrasion of Counterpart Material)

In the above reciprocating abrasion test using the Friction Player, the weight loss of the ball-shaped silicon dioxide measuring probe due to abrasion with the coating film was measured.

### (Friction Coefficient of Coating Film)

The friction coefficient of the coating film was measured with the use of a Tribo Gear (manufactured by Shinto Scientific Co., Ltd.).

### (Surface Segregation Rate of Fluorine Atoms)

The surface of the fluororesin coating film was subjected to EDX (energy dispersive X-ray analysis), and a depth of 0.5 to 1 μm from the surface was measured, and a proportion [mass %] of fluorine atoms segregated on the surface was calculated.

TABLE 1

| | Example | Example | Example | Example | Example | Example | Example |
|---|---|---|---|---|---|---|---|
| | 1 | 2 | 3 | 4 | 5 | 6 | 7 |
| Fluororesin (FEP) | | 13.30 | | | | | |
| particle A | | | | | | | |
| Fluororesin (FEP) | 13.30 | | | | 11.43 | 15.18 | 17.08 |
| particle B | | | | | | | |
| Fluororesin (FEP) | | | 13.30 | | | | |
| particle C | | | | | | | |
| Fluororesin (FEP) | | | | | | | |
| particle D | | | | | | | |
| Fluororesin (FEP) | | | | | | | |
| particle E | | | | | | | |
| Fluororesin (FEP) | | | | | | | |
| particle F | | | | | | | |
| Fluororesin (FEP) | | | | 13.30 | | | |
| particle G | | | | | | | |
| Fluororesin (FEP) | | | | | | | |
| particle H | | | | | | | |
| Fluororesin (PFA) | | | | | | | |
| particle I | | | | | | | |
| Fluororesin (PTFE) | | | | | | | |
| particle J | | | | | | | |
| Fluororesin (PTFE) | | | | | | | |
| particle K | | | | | | | |
| Binder resin L: PAI | 19.00 | 19.00 | 19.00 | 19.00 | 25.39 | 12.66 | 6.36 |
| varnish (NMP) | | | | | | | |
| Binder resin M: PAI | | | | | | | |
| varnish (MPA) | | | | | | | |
| Binder resin N: PEI | | | | | | | |
| varnish (NMP) | | | | | | | |
| Binder resin O: PI | | | | | | | |
| varnish (NMP) | | | | | | | |
| Binder resin P: PEEK | | | | | | | |
| dispersion (NMP) | | | | | | | |
| Coloring pigment Q: | | | | | | | |
| Titanium oxide | | | | | | | |
| Coloring pigment R: | | | | | | | |
| Carbon black | | | | | | | |
| Filler S: Talc | | | | | | | |
| Filler T: Graphite | | | | | | | |
| Filler U: Quartz | | | | | | | |
| Filler V: Zirconia | | | | | | | |
| Filler W: Silicon carbide | | | | | | | |
| N-methylpyrrolidone | 44.65 | 44.65 | 44.65 | 44.65 | 40.10 | 49.03 | 53.53 |
| MPA | | | | | | | |
| Methyl isobutyl ketone | 23.05 | 23.05 | 23.05 | 23.05 | 23.06 | 23.13 | 23.08 |
| Total | 100.0 | 100.0 | 100.0 | 100.0 | 100.0 | 100.0 | 100.0 |
| Mass ratio of | 70/30 | 70/30 | 70/30 | 70/30 | 60/40 | 80/20 | 90/10 |
| fluororesin to binder | | | | | | | |
| resin | | | | | | | |
| Stability of composition | Good | Good | Good | Good | Good | Good | Good |
| Abrasion resistance | 1,900 | 1,780 | 1,980 | 1,430 | 1,770 | 1,500 | 1,400 |
| (FP) 15 μm, 1 kg, 25° C. | | | | | | | |
| Abrasion resistance | 1050 | 900 | 1150 | 690 | 890 | 780 | 650 |
| (FP) 15 μm, 1 kg, | | | | | | | |
| 150° C. | | | | | | | |
| Weight loss of | 0 | 0 | 0 | 0 | 10 | 0 | 0 |
| counterpart material | | | | | | | |
| mg (/500 times) | | | | | | | |
| Friction coefficient | 0.07 | 0.07 | 0.07 | 0.07 | 0.07 | 0.06 | 0.06 |
| Surface segregation | 73 | 69 | 75 | 59 | 62 | 79 | 81 |
| rate of fluorine atoms | | | | | | | |
| [mass %] | | | | | | | |

TABLE 2

| | Example | Example | Example | Example | Example | Example | Example | Example |
|---|---|---|---|---|---|---|---|---|
| | 8 | 9 | 10 | 11 | 12 | 13 | 14 | 15 |
| Fluororesin (FEP) | | | | | | | | |
| particle A | | | | | | | | |
| Fluororesin (FEP) | 13.30 | 13.30 | 13.30 | 13.30 | 12.90 | 12.05 | 12.05 | 12.05 |
| particle B | | | | | | | | |
| Fluororesin (FEP) | | | | | | | | |
| particle C | | | | | | | | |
| Fluororesin (FEP) | | | | | | | | |
| particle D | | | | | | | | |
| Fluororesin (FEP) | | | | | | | | |
| particle E | | | | | | | | |
| Fluororesin (FEP) | | | | | | | | |
| particle F | | | | | | | | |
| Fluororesin (FEP) | | | | | | | | |
| particle G | | | | | | | | |
| Fluororesin (FEP) | | | | | | | | |
| particle H | | | | | | | | |
| Fluororesin (PFA) | | | | | | | | |
| particle I | | | | | | | | |
| Fluororesin (PTFE) | | | | | | | | |
| particle J | | | | | | | | |
| Fluororesin (PTFE) | | | | | | | | |
| particle K | | | | | | | | |
| Binder resin L: PAI | | | | | 18.46 | 17.25 | 17.25 | 17.25 |
| varnish (NMP) | | | | | | | | |
| Binder resin M: PAI | 16.29 | | | | | | | |
| varnish (MPA) | | | | | | | | |
| Binder resin N: PEI | | 22.79 | | | | | | |
| varnish (NMP) | | | | | | | | |
| Binder resin O: PI | | | 22.79 | | | | | |
| varnish (NMP) | | | | | | | | |
| Binder resin P: | | | | 22.79 | | | | |
| PEEK dispersion | | | | | | | | |
| (NMP) | | | | | | | | |
| Coloring pigment | | | | | 0.08 | | | |
| Q: Titanium oxide | | | | | | | | |
| Coloring pigment | | | | | 0.43 | | | |
| R: Carbon black | | | | | | | | |
| Filler S: Talc | | | | | | 1.80 | | |
| Filler T: Graphite | | | | | | | 1.80 | |
| Filler U: Quartz | | | | | | | | 1.80 |
| Filler V: Zirconia | | | | | | | | |
| Filler W: Silicon | | | | | | | | |
| carbide | | | | | | | | |
| N- | | 40.85 | 40.85 | 40.85 | 45.25 | 46.05 | 46.05 | 46.05 |
| methylpyrrolidone | | | | | | | | |
| MPA | 47.40 | | | | | | | |
| Methyl isobutyl | 23.00 | 23.05 | 23.05 | 23.05 | 22.83 | 22.83 | 22.83 | 22.83 |
| ketone | | | | | | | | |
| Total | 100.0 | 100.0 | 100.0 | 100.0 | 100.0 | 100.0 | 100.0 | 100.0 |
| Mass ratio of | 70/30 | 70/30 | 70/30 | 70/30 | 70/30 | 70/30 | 70/30 | 70/30 |
| fluororesin to | | | | | | | | |
| binder resin | | | | | | | | |
| Stability of | Good | Good | Good | Good | Good | Good | Good | Good |
| composition | | | | | | | | |
| Abrasion | 1,800 | 1,620 | 1,630 | 1,670 | 1,890 | 2,010 | 2,100 | 2, 990 |
| resistance (FP) 15 | | | | | | | | |
| μm, 1 kg, 25° C. | | | | | | | | |
| Abrasion | 990 | 830 | 820 | 840 | 1050 | 1090 | 1150 | 1490 |
| resistance (FP) 15 | | | | | | | | |
| μm, 1 kg, 150° C. | | | | | | | | |
| Weight loss of | 0 | 0 | 0 | 0 | 0 | 0 | 0 | 0.1 |
| counterpart | | | | | | | | |
| material mg (/500 | | | | | | | | |
| times) | | | | | | | | |
| Friction coefficient | 0.06 | 0.07 | 0.07 | 0.07 | 0.07 | 0.07 | 0.07 | 0.08 |
| Surface | 71 | 73 | 68 | 60 | 67 | 61 | 64 | 65 |
| segregation rate of | | | | | | | | |
| fluorine atoms | | | | | | | | |
| [mass %] | | | | | | | | |

TABLE 3

| | Example | Example | Example | Example | Example |
|---|---|---|---|---|---|
| | 16 | 17 | 18 | 19 | 20 |
| Fluororesin (FEP) particle A | | | | | |
| Fluororesin (FEP) particle B | 12.05 | 12.05 | 11.35 | 12.05 | 12.05 |
| Fluororesin (FEP) particle C | | | | | |
| Fluororesin (FEP) particle D | | | | | |
| Fluororesin (FEP) particle E | | | | | |
| Fluororesin (FEP) particle F | | | | | |
| Fluororesin (FEP) particle G | | | | | |
| Fluororesin (FEP) particle H | | | | | |
| Fluororesin (PFA) particle I | | | | | |
| Fluororesin (PTFE) particle J | | | | | |
| Fluororesin (PTFE) particle K | | | | | |
| Binder resin L: PAI varnish (NMP) | 17.25 | 17.25 | 16.25 | 17.25 | 17.25 |
| Binder resin M: PAI varnish (MPA) | | | | | |
| Binder resin N: PEI varnish (NMP) | | | | | |
| Binder resin O: PI varnish (NMP) | | | | | |
| Binder resin P: PEEK dispersion (NMP) | | | | | |
| Coloring pigment Q: Titanium oxide | | | | 0.04 | 0.04 |
| Coloring pigment R: Carbon black | | | | 0.22 | 0.22 |
| Filler S: Talc | | | | | |
| Filler T: Graphite | | | | 1.54 | |
| Filler U: Quartz | | | 2.80 | | |
| Filler V: Zirconia | 1.80 | | | | 1.54 |
| Filler W: Silicon carbide | | 1.80 | | | |
| N-methylpyrrolidone | 46.05 | 46.05 | 46.65 | 46.05 | 46.05 |
| MPA | | | | | |
| Methyl isobutyl ketone | 22.83 | 22.83 | 22.90 | 22.83 | 22.83 |
| Total | 100.0 | 100.0 | 100.0 | 100.0 | 100.0 |
| Mass ratio of fluororesin to binder resin | 70/30 | 70/30 | 70/30 | 70/30 | 70/30 |
| Stability of composition | Good | Good | Good | Good | Good |
| Abrasion resistance (FP) 15 μm, 1 kg, 25° C. | 3,520 | 4,590 | 2,880 | 1,990 | 3,010 |
| Abrasion resistance (FP) 15 μm, 1 kg, 150° C. | 1720 | 2030 | 1450 | 1060 | 1650 |
| Weight loss of counterpart material mg (/500 times) | 0.25 | 0.3 | 0.16 | 0 | 0.21 |
| Friction coefficient | 0.09 | 0.09 | 0.09 | 0.08 | 0.08 |
| Surface segregation rate of fluorine atoms [mass %] | 63 | 62 | 58 | 66 | 63 |

TABLE 4

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Fluororesin (FEP) | | | | | | |
| particle A | | | | | | |
| Fluororesin (FEP) | | | | | | |
| particle B | | | | | | |
| Fluororesin (FEP) | | | | | | |
| particle C | | | | | | |
| Fluororesin (FEP) | | | | | | 13.30 |
| particle D | | | | | | |
| Fluororesin (FEP) | | | | | | |
| particle E | | | | | | |
| Fluororesin (FEP) | | | | 13.30 | | |
| particle F | | | | | | |
| Fluororesin (FEP) | | | | | | |
| particle G | | | | | | |
| Fluororesin (FEP) | | | | | 13.30 | |
| particle H | | | | | | |
| Fluororesin (PFA) | | | 13.30 | | | |
| particle I | | | | | | |
| Fluororesin | 13.30 | | | | | |
| (PTFE) particle J | | | | | | |
| Fluororesin | | 13.30 | | | | |
| (PTFE) particle K | | | | | | |
| Binder resin L: PAI | 19.00 | 19.00 | 19.00 | 19.00 | 19.00 | 19.00 |
| varnish (NMP) | | | | | | |
| Binder resin M: | | | | | | |
| PAI varnish (MPA) | | | | | | |
| Binder resin N: | | | | | | |
| PEI varnish (NMP) | | | | | | |
| Binder resin O: PI | | | | | | |
| varnish (NMP) | | | | | | |
| Binder resin P: | | | | | | |
| PEEK dispersion | | | | | | |
| (NMP) | | | | | | |
| Coloring pigment | | | | | | |
| Q: Titanium oxide | | | | | | |
| Coloring pigment | | | | | | |
| R: Carbon black | | | | | | |
| Filler S: Talc | | | | | | |
| Filler T: Graphite | | | | | | |
| Filler U: Quartz | | | | | | |
| Filler V: Zirconia | | | | | | |
| Filler W: Silicon | | | | | | |
| carbide | | | | | | |
| N- | 44.65 | 44.65 | 44.65 | 44.65 | 44.65 | 44.65 |
| methylpyrrolidone | | | | | | |
| MPA | | | | | | |
| Methyl isobutyl | 23.05 | 23.05 | 23.05 | 23.05 | 23.05 | 23.05 |
| ketone | | | | | | |
| Total | 100.0 | 100.0 | 100.0 | 100.0 | 100.0 | 100.0 |
| Mass ratio of | 70/30 | 70/30 | 70/30 | 70/30 | 70/30 | 70/30 |
| fluororesin to | | | | | | |
| binder resin | | | | | | |
| Stability of | Poor | Good | Good | Poor | Good | Good |
| composition | | | | | | |
| Abrasion | — | 970 | 770 | — | 1040 | 950 |
| resistance (FP) 15 | | | | | | |
| μm, 1 kg, 25° C. | | | | | | |
| Abrasion | — | 400 | 390 | — | 490 | 480 |
| resistance (FP) 15 | | | | | | |
| μm, 1 kg, 150° C. | | | | | | |
| Weight loss of | — | 0 | 0 | — | 0 | 0 |
| counterpart | | | | | | |
| material mg (/500 | | | | | | |
| times) | | | | | | |
| Friction coefficient | — | 0.09 | 0.1 | — | 0.09 | 0.09 |
| Surface | — | 40 | 37 | — | — | — |
| segregation rate of | | | | | | |
| fluorine atoms | | | | | | |
| [mass %] | | | | | | |

TABLE 5

| | Comparative | Comparative | Comparative |
|---|---|---|---|
| | Example 7 | Example 8 | Example 9 |
| Fluororesin (FEP) particle A | | | |
| Fluororesin (FEP) particle B | | 9.52 | 18.03 |
| Fluororesin (FEP) particle C | | | |
| Fluororesin (FEP) particle D | | | |
| Fluororesin (FEP) particle E | 13.30 | | |
| Fluororesin (FEP) particle F | | | |
| Fluororesin (FEP) particle G | | | |
| Fluororesin (FEP) particle H | | | |
| Fluororesin (PFA) particle I | | | |
| Fluororesin (PTFE) particle J | | | |
| Fluororesin (PTFE) particle K | | | |
| Binder resin L: PAI varnish (NMP) | 19.00 | 31.74 | 3.16 |
| Binder resin M: PAI varnish (MPA) | | | |
| Binder resin N: PEI varnish (NMP) | | | |
| Binder resin O: PI varnish (NMP) | | | |
| Binder resin P: PEEK dispersion (NMP) | | | |
| Coloring pigment Q: Titanium oxide | | | |
| Coloring pigment R: Carbon black | | | |
| Filler S: Talc | | | |
| Filler T: Graphite | | | |
| Filler U: Quartz | | | |
| Filler V: Zirconia | | | |
| Filler W: Silicon carbide | | | |
| N-methylpyrrolidone | 44.65 | 35.75 | 55.80 |
| MPA | | | |
| Methyl isobutyl ketone | 23.05 | 23.00 | 22.98 |
| Total | 100.0 | 100.0 | 100.0 |
| Mass ratio of fluororesin to binder resin | 70/30 | 50/50 | 95/5 |
| Stability of composition | Good | Good | Good |
| Abrasion resistance (FP)15 μm, 1 kg, 25° C. | 900 | 1,200 | 780 |
| Abrasion resistance (FP)15 μm, 1 kg, 150° C. | 430 | 500 | 430 |
| Weight loss of counterpart material mg (/500 times) | 0 | 0 | 0 |
| Friction coefficient | 0.07 | 0.1 | 0.07 |
| Surface segregation rate of fluorine atoms [mass %] | — | 45 | 88 |

It has been shown that the coating composition of the present disclosure can stably incorporate a high amount of fluororesin particles. In addition, it has been shown that also in the obtained coating film, the fluororesin is unevenly distributed on the surface side, which causes excellent abrasion resistance.

### INDUSTRIAL APPLICABILITY

The coating composition of the present disclosure has the above-described composition, and accordingly can form a coating film having excellent sliding properties. The laminate of the present disclosure is excellent in sliding properties, and accordingly can be suitably used as an industrial component such as a sliding member.

1. A coating composition comprising a particle of a tetrafluoroethylene/hexafluoropropylene copolymer, a binder resin and a liquid medium, wherein
the binder resin is at least one selected from the group consisting of a polyamide-imide resin, a polyetherimide resin, a polyimide resin and a polyaryl ether ketone resin; and
the particle of the tetrafluoroethylene/hexafluoropropylene copolymer has a melt flow rate of 10 to 25 (g/10 min), a melting point of 270° C. or lower, and a median diameter (D50) of 0.1 to less than 10 μm, and
a mass ratio of the particle of the tetrafluoroethylene/hexafluoropropylene copolymer to the binder resin is 55/45 to 94/6.

2. The coating composition according to claim 1, wherein the liquid medium includes at least one selected from the group consisting of N-methyl-2-pyrrolidone, N-ethyl-2-pyrrolidone, N-butyl-2-pyrrolidone, 3-methoxy-N,N-dimethylpropanamide, and N, N-dimethylacetamide.

3. The coating composition according to claim 1, further comprising a coloring pigment.

4. The coating composition according to claim 1, further comprising a filler.

5. A coating film, wherein the coating film is formed from the coating composition according to claim 1.

6. A laminate comprising a coating film formed from the coating composition according to claim 1, on a substrate.

7. The laminate according to claim 6, wherein the substrate is a metal substrate.

8. The laminate according to claim 6, wherein the laminate is a sliding member.
